(19) United States
(12) Patent Application Publication
(10) Pub. No.: US 2022/0034402 A1
(43) Pub. Date: Feb. 3, 2022

(54) COMPOSITE PUMP PACKING SEALING ELEMENTS

(71) Applicant: Vulcan Industrial Holdings, LLC, Houston, TX (US)

(72) Inventors: Mahdi Kiani, Tomball, TX (US); Jason David Smith, Porter, TX (US); Chance Ray Mullins, Spring, TX (US)

(73) Assignee: Vulcan Industrial Holdings, LLC, Houston, TX (US)

(21) Appl. No.: 17/153,507

(22) Filed: Jan. 20, 2021

Related U.S. Application Data
(60) Provisional application No. 63/058,819, filed on Jul. 30, 2020.

(51) Int. Cl. F16J 9/20; F04B 47/02; F04B 19/22

(52) U.S. Cl. CPC F16J 9/20; E21B 43/2607; F04B 19/22; F04B 47/02

(57) ABSTRACT

A sealing assembly for a pump includes a header ring having a tapered radially outer surface and a sloped radially inner surface. The assembly also includes a first seal configured to couple to the header ring, the first seal having a groove that receives a bead extending from the header ring. The assembly further includes a second seal axially aligned with the first seal.

### CROSS REFERENCE TO RELATED APPLICATIONS

This application claims priority to and the benefit of co-pending U.S. Provisional Application Ser. No. 63/058,819 filed Jul. 30, 2020 titled “COMPOSITE PUMP PACKING SEALING ELEMENTS,” the full disclosure of which is hereby incorporated herein by reference in its entirety for all purposes.

### TECHNICAL FIELD

Embodiments of the subject matter disclosed herein generally relate to pump systems, and in particular to sealing systems.

### BACKGROUND

Pumping systems may be used in a variety of applications, such as industrial applications where pumping systems are used to elevate a working fluid pressure. One such application is hydraulic fracturing systems, where high pressure pumps are used to increase a fluid pressure of a working fluid (e.g., fracturing fluid, slurry, etc.) for injection into an underground formation. The working fluid may include particulates, which are injected into fissures of the formation. When the fluid is removed from the formation, the particulates remain and “prop” open the fissures, facilitating flow of oil and gas. In many applications, reciprocating pumps are used where a fluid is introduced into a fluid end inlet passage and out through an outlet passage. A plunger reciprocates within a bore to add energy to the fluid. Due to the particulates and corrosive nature of the working fluid, various sealing elements may be utilized to block fluid ingress that may damage sealing surfaces.

### SUMMARY

Applicant recognized the problems noted above herein and conceived and developed embodiments of systems and methods, according to the present disclosure, for pump control operations.

In an embodiment, a sealing assembly for a pump includes a header ring having a tapered radially outer surface and a sloped radially inner surface. The assembly also includes a first seal configured to couple to the header ring, the first seal having a groove that receives a bead extending from the header ring. The assembly further includes a second seal axially aligned with the first seal.

In an embodiment, a pumping system includes a housing, a plunger configured to reciprocate along an axis of the housing, and a packing assembly positioned between at least a portion of the housing and the plunger. The packing assembly includes a header ring having an outer surface bearing against the housing and an inner surface bearing against the plunger, the header ring having a thickness such that the plunger compresses the header ring against the housing, wherein the outer surface includes tapered portion and the inner surface includes sloped entry radius at an axially bottom portion. The packing assembly also includes a seal positioned axially higher than and coupled to the header ring, the seal having a groove configured to receive a bead of the header ring, the bead extending axially away from the bottom portion, wherein the seal includes a radially extending sealing feature along a length of the seal.

In an embodiment, a packing stack includes a header ring extending axially from a bottom to a top, the top having a bead, the header ring having an inner surface with a curved profile extending from the top to the bottom, a bottom thickness being less than a midpoint thickness, and an outer surface with a tapered profile extending from the top to the bottom, the tapered profile arranged at an angle such that a top thickness is less than the bottom thickness. The packing stack also includes a seal extending axially from a bottom end to a top end, at least a portion of the bottom end overlapping the top of the header ring, the seal having a groove that receives the bead, an inner seal surface, and an outer seal surface, the seal being positioned axially aligned with the header ring.

### BRIEF DESCRIPTION OF THE DRAWINGS

The present technology will be better understood on reading the following detailed description of non-limiting embodiments thereof, and on examining the accompanying drawings, in which:

FIG. 1 is a schematic cross-sectional view of a prior art pump assembly;

FIG. 2 is a schematic cross-sectional view of a prior art sealing assembly;

FIG. 3 is a schematic cross-sectional view of a prior art header ring;

FIG. 4 is a schematic cross-sectional view of a prior art packing stack;

FIG. 5A is a perspective view of an embodiment of a packing stack, in accordance with embodiments of the present disclosure;

FIG. 5B is a cross-sectional view of an embodiment of a packing stack, in accordance with embodiments of the present disclosure;

FIG. 5C is a sectional view of an embodiment of a packing stack, in accordance with embodiments of the present disclosure;

FIG. 6A is a perspective view of an embodiment of a packing stack, in accordance with embodiments of the present disclosure;

FIG. 6B is a cross-sectional view of an embodiment of a packing stack, in accordance with embodiments of the present disclosure;

FIG. 6C is a sectional view of an embodiment of a packing stack, in accordance with embodiments of the present disclosure;

FIG. 7A is a perspective view of an embodiment of a packing stack, in accordance with embodiments of the present disclosure;

FIG. 7B is a cross-sectional view of an embodiment of a packing stack, in accordance with embodiments of the present disclosure;

FIG. 7C is a sectional view of an embodiment of a packing stack, in accordance with embodiments of the present disclosure;

FIG. 8A is a perspective view of an embodiment of a packing stack, in accordance with embodiments of the present disclosure;

FIG. 8B is a cross-sectional view of an embodiment of a packing stack, in accordance with embodiments of the present disclosure;

FIG. 8C is a sectional view of an embodiment of a packing stack, in accordance with embodiments of the present disclosure;

FIG. 9A is a perspective view of an embodiment of a packing stack, in accordance with embodiments of the present disclosure;

FIG. 9B is a cross-sectional view of an embodiment of a packing stack, in accordance with embodiments of the present disclosure; and

FIG. 9C is a sectional view of an embodiment of a packing stack, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Additionally, like reference numbers may be used for like features throughout the disclosure, however, such use for convenience only and not intended to limit the scope of the present disclosure.

Embodiments of the present disclosure include packing sealing elements (e.g., a header ring and the chevron V ring(s)). The header ring includes a geometry with a sloped entry radius to reduce seal wear (e.g., eliminate nibbling) and aid in installation of a plunger without causing damage to a header ring. The header ring also includes an angled outer diameter surface, which may have an angle between 0.5-8 degrees, respective to a centerline plunger bore axis to aid in tight fitment of the header ring in the fluid end bore and enhanced sealing. Various embodiments include one or more chevron V rings, which may have commercially available geometries, positioned behind the header ring forming a stack of a certain height. Both the header ring and chevron V ring(s) may be constructed from polyurethane. The polyurethane may be a commercially available composition, or a custom blended engineered composite. The polyurethane composite may include additional elements in order to form a composite polyurethane compound formulated for optimal wear resistance and chemical resistance when used in hydraulic fracturing pump operations. Such materials that may be blended in with the polyurethane to form the composite material are glass fibers, carbon fibers, carbon nanotubes, graphene, polytetrafluoroethylene (PTFE), aramid-fabrics, Kevlar fabrics, alumina powder, ceramic fiber, white graphene, nano-ceramics, or some combination of these materials. The header ring is formulated with a hardness in the range of 50-100 shore A durometer. The chevron V rings may be formulated with a hardness in the range of 50-100 shore D durometer.

As noted above, various embodiments of the present disclosure may include packing sealing elements with a geometry that includes a sloped entry radius to reduce seal wear. The header ring may also have an angled outer diameter surface. The header ring may also include, on its outer diameter, one or more flared sealing winglets, as described herein, that are designed for enhanced sealability with the packing bore of the fluid end. One or more chevron V rings may be positioned behind the header ring, forming a stack of a certain height. The chevron V rings including one or more flared sealing winglets on both the inner diameter and outer diameter, as shown herein, and may act as backup sealing lips for enhanced sealing. Both the header ring and chevron V ring(s) are constructed from polyurethane, in certain embodiments. The polyurethane may be a commercially available composition, or a custom blended engineered composite. The polyurethane composite may include additional elements in order to form a composite polyurethane compound formulated for optimal wear resistance and chemical resistance when used in hydraulic fracturing pump operations. Such materials that may be blended in with the polyurethane to form the composite are glass fibers, carbon fibers, carbon nanotubes, graphene, PTFE, aramid-fabrics, Kevlar fabrics, alumina powder, ceramic fiber, white graphene, nano-ceramics or some combination of these materials. The header ring may be formed with a hardness in the range of 50-100 shore A durometer. The chevron V rings may be formed with a hardness in the range of with a hardness in the range of 50-100 shore D durometer.

Embodiments of the present disclosure may also include packing sealing elements, as included above such as a header ring and chevron V ring(s), where one or more chevron V rings may be positioned behind the header ring forming a stack of a certain height. The chevron pressure rings may include one or more annular grooved recesses on the inner diameter, as described below. These annular grooved recesses may act as reservoirs for collecting lubricating grease or oil being pumped into the packing gland while the pump is in operation, thereby reducing friction by evenly dispersing grease around and/or along the reciprocating plunger and thus reducing overall frictional wear and heat buildup in the sealing elements, extending packing sealing element service life. Both the header ring and chevron V rings may be formed from polyurethane. The polyurethane may be a commercially available composition, or a custom blended engineered composite. The polyurethane composite may include additional elements in order to form a composite compound formulated for optimal wear resistance and chemical resistance when used in hydraulic fracturing pump operations. Such materials that may be blended in with the polyurethane to form the composite are glass fibers, carbon fibers, carbon nanotubes, graphene, Teflon, Aramid-fabrics, Kevlar fabrics, alumina powder, ceramic fiber, white graphene, nano-ceramics or some combination of these materials. The header ring may be formed with a hardness in the range of 50-100 shore A durometer. The chevron V rings may be formed with a hardness in the range of with a hardness in the range of 50-100 shore D durometer.

Embodiments of the present disclosure include packing sealing elements, such as a header ring and chevron V ring(s), where the chevron V rings may include, on their inner diameter, an insert of PTFE/Teflon or similar ultra-low/low friction material. These PTFE inserts can be bonded to the chevron V rings or snapped in place, the inserts acting as low friction wiper seals, which serve to retain grease close to the sealing areas of the chevron V rings where most frictional wear occurs during pumping operations. Lubricating grease or oil is pumped into the packing gland while the pump is in operation, reducing friction by evenly dispersing grease around/along the reciprocating plunger and thus reducing overall frictional wear and heat buildup in the sealing elements, extending packing sealing element service life. Both the header ring and chevron V rings may be from polyurethane. The polyurethane may be a commercially available composition, or a custom blended engineered composite. The polyurethane composite may include additional elements in order to form a unique and proprietary composite compound formulated for optimal wear resistance and chemical resistance when used in hydraulic fracturing pump operations. Such materials that may be blended in with the polyurethane to form the composite are glass fibers, carbon fibers, carbon nanotubes, graphene, Teflon, Aramid-fabrics, Kevlar fabrics, alumina powder, ceramic fiber, white graphene, nano-ceramics or some combination of these materials. The header ring may be formed with a hardness in the range of 50-100 shore A durometer. The chevron V rings may be formed from a material with a hardness in the range of 50-100 shore D durometer. In embodiments, the chevron V rings may be formed from a material, such as PTFE/Teflon, with a hardness in the range of 50-150 shore A durometer.

Embodiments of the present disclosure include packing sealing elements, such as a header ring and chevron V ring(s), where the header ring also has an insert of a different material on its outer diameter that acts as a reinforcing stiffener. In various embodiments, the insert may include a PTFE or Teflon material, but it should be appreciated that a variety of materials may be included. Furthermore, in certain embodiments, combinations of materials may be utilized as well as multiple inserts, which may all be different materials. The header ring also includes a barb like feature on the top side designed to tightly interlock with the chevron V rings when assembled together. One or more chevron V rings are positioned behind the header ring forming a stack of a certain height. The chevron V rings include a geometry that interlocks with the top barb feature of the header ring. Both the header ring and chevron V rings may be constructed from polyurethane. The polyurethane may be a commercially available composition, or a custom blended engineered composite. The polyurethane composite may include additional elements in order to form a composite compound formulated for optimal wear resistance and chemical resistance when used in hydraulic fracturing pump operations. Such materials that may be blended in with the polyurethane to form the composite are glass fibers, carbon fibers, carbon nanotubes, graphene, Teflon, Aramid-fabrics, Kevlar fabrics, alumina powder, ceramic fiber, white graphene, nano-ceramics or some combination of these materials. The header ring may be formed with a hardness in the range of 50-100 shore A durometer. The chevron V rings may be formed with a hardness in the range of with a hardness in the range of 50-100 shore D durometer. The insert may be formed with a hardness in the range of 50-100 shore A durometer. The insert may be formed from a material with a hardness in the range of 50-100 shore D durometer. In embodiments, the insert may be formed from a material, such as PTFE/Teflon, with a hardness in the range of 50-150 shore A durometer.

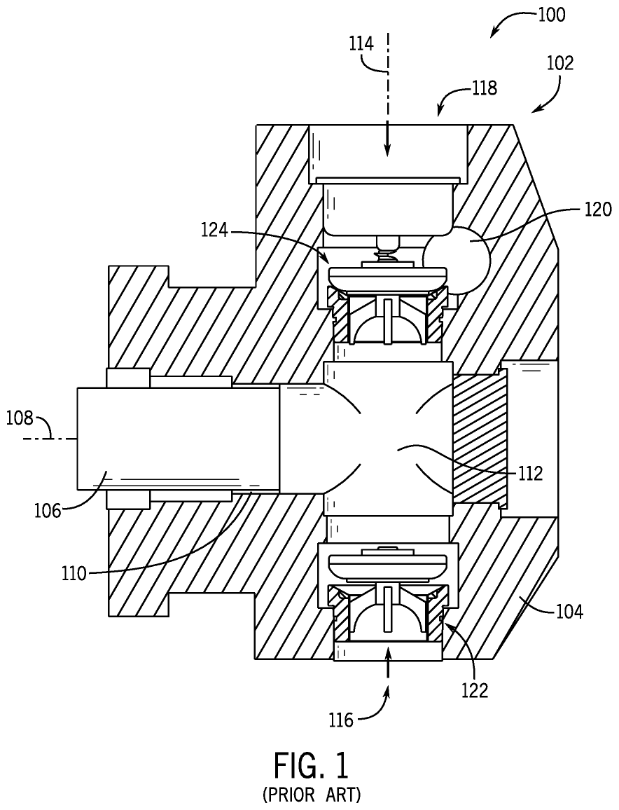

FIG. 1 is a schematic cross-sectional view of an embodiment of a pump assembly 100, which may also be referred to as a reciprocating pump assembly and/or a reciprocating pump. The pump assembly 100 may be utilized during hydraulic fracturing operations, among other operations, where a working fluid (e.g., fracturing fluid, slurry, etc.) is introduced into the pump and energy is added to the working fluid to increase a pressure of the working fluid. Fracturing fluid, by way of example only, may include corrosives and also particulates, such as sand or ceramics, which are utilized during fracturing operations. These corrosives and particulates cause erosion within the pump assembly 100, which may undesirably affect fracturing operations and lead to down times to replace various components. Additionally, the fracturing fluids may include corrosive acids and the like, which may wear down components of the pump assembly 100.

It should be appreciated that various components of the pump assembly 100 have been removed for clarity with the following discussion. For example, a power end has been removed in favor of focusing on the illustrated fluid end 102 of the pump assembly 100. The power end may include a crankshaft that is driven by an engine or motor to facilitate operations. The fluid end 102 includes a fluid end block 104 that may house one or more components discussed herein. A plunger rod 106 is driven (e.g., via the crankshaft) to reciprocate within the fluid end block 104 along a plunger axis 108. The plunger rod 106 is positioned within a bore 110 extending through at least a portion of the fluid end block 104. The illustrated bore 110 is arranged along the plunger axis 108 (e.g., first axis) and intersects a pressure chamber 112, which is arranged along a pressure chamber axis 114 (e.g., second axis), which is positioned substantially perpendicular to the plunger axis 108. It should be appreciated that the pump assembly 100 may include multiple plunger rod and pressure chamber arrangements, which may be referred to as a plunger throw. For example, the pump assembly 100 may be a triplex pump, quadplex pump, quintuplex pump, and the like.

The illustrated fluid end block 104 includes an inlet passage 116 and an outlet chamber 118, which are generally coaxial and arranged along the pressure chamber axis 114. In other words, the inlet passage 116 and the outlet chamber 118 are axially aligned with respect to one another and/or the pressure chamber 112. Fluid enters the pressure chamber 112 via the inlet passage 116, for example on an up stroke of the plunger rod 106, and is driven out of the pressure chamber 112 an outlet passage 120, for example on a down stroke of the plunger 106.

Respective valve assemblies 122, 124 are arranged within the inlet passage 116 and the outlet chamber 118. These valve assemblies 122, 124 are spring loaded in the illustrated embodiment, but it should be appreciated that such an arrangement is for illustrative purposes only. In operation, a differential pressure may drive movement of the valve assemblies. For example, as the plunger rod 106 is on the upstroke, pressure at the inlet passage 116 may overcome the spring force of the valve assembly 122, thereby driving fluid into the pressure chamber 112. However, on the down stroke, the valve assembly 122 may be driven to a closed position, while the spring force of the valve assembly 124 is overcome, thereby enabling the fluid to exit via the outlet passage 120.

Piston pumps or plunger pumps, such as the pump assembly 100 shown in FIG. 1, are positive displacement pumps and are commonly used in environments where the fluids that are being handled pose problems such as high temperatures, viscous media, or solids-charged liquids. One such example is in oil and gas operations, particularly fracturing operations, where solids laden fluids may be used. Examples of these fluids include drilling fluids, muds, cement slurries, fracturing slurries, acids and the like, which frequently must be pumped under high pressure into the well. These abrasive fluids provide challenges for the various sealing interfaces of the pumps. As a result, various sealing elements may be disposed at the sealing interfaces to block fluid flow out of the fluid end 102. Prior art chevron seals and header rings are constructed from rubber or a rubber/aramid fabric composite. These sealing elements wear out quickly in high pressure hydraulic fracturing operations, causing leakage and subsequent equipment downtime to repair and/or sever equipment damage due to high pressure fluid leakage eroding the fluid end bores. A higher performance packing design is needed for both the header and chevron V rings.

Embodiments of the present disclosure described herein may overcome one or more problems identified with traditional sealing elements. By way of example, embodiments may provide one or more sealing elements formed from materials specifically formulated for suitability with fracturing or other high pressure, high temperature, severe service operations. For example, sealing elements may be formed from a thermoplastic polyurethane (TPU). Furthermore, various sealing geometries may be deployed in order to provide improved sealing performance.

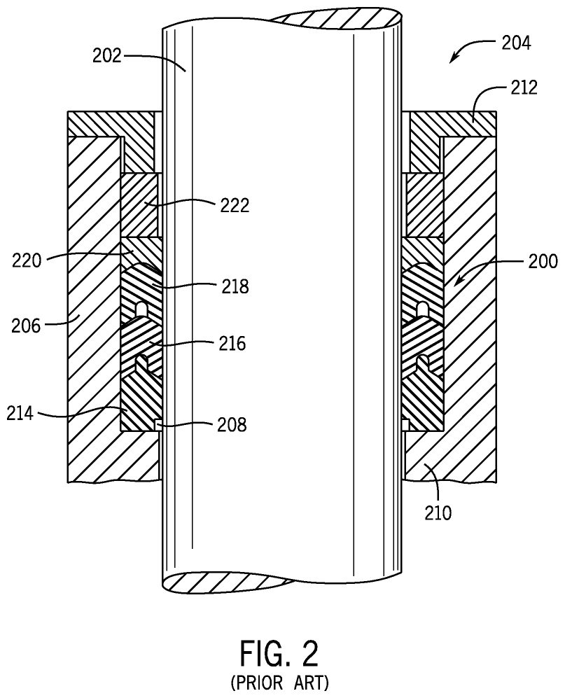

FIG. 2 is a cross-sectional schematic view of a prior art sealing assembly 200. The illustrated sealing assembly 200 includes a plunger 202 positioned within a stuffing box 204 in a housing 206. The plunger 202 is arranged to reciprocate within the housing 204, for example, through a bore 208 formed in the housing 206. The illustrated housing 204 further includes a shoulder 210 that receives and supports the sealing assembly 200. In this example, the sealing assembly 200 includes an annular gland 212, annular header ring 214, an annular first seal ring 216, and an annular second seal ring 218. Further illustrated are a top annular adaptor ring 220 and an annular bushing 222.

In the illustrated configuration, the header ring 214 acts as a wiper ring to prevent or block abrasives or solids from entering the region including the seal rings 216, 218. The annular gland 212 compresses the various sealing elements within the housing 206. As shown, vertical features or nubs (e.g., beads) may interface with grooves of adjacent sealing elements to anchor the components together. In these prior art configurations, the components are often metallic, such as brass.

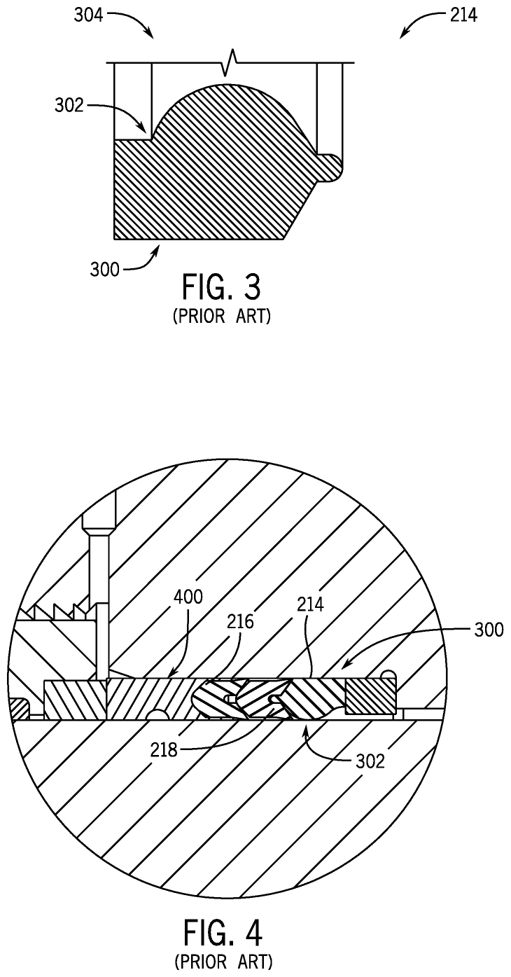

FIG. 3 is a cross-sectional view of the prior art header ring 214. As shown, the header ring 214 includes a flat vertical entry surface 300, which may be compressed against a wall of the housing 206 (FIG. 2). Additionally, a recessed corner edge 302 is illustrated at a front 304 of the header ring 214, with “front” in this instance corresponding to the portion bearing against the plunger 106 (FIG. 1). That is, the “front” is the radially inward side of the header ring 214. As illustrated, the recessed corner 302 forms a stress area that may be undesirable for sealing operations. By way of example, particulates and the like may collect or otherwise affect the recessed corner edge 302, which may cause wear and eventual tearing of the seal. As will be described below, embodiments of the present disclosure may be used to overcome these problems, among other shortcomings, in the prior art.

FIG. 4 illustrates a cross-sectional view of a prior art packing stack 400 that may be utilized in various pumping operations, such as a hydraulic fracturing operations. The illustrated stack 400 includes the header ring 214, which includes the entry surface 300 and the recessed corner edge 302 described above. It should be appreciated that the header ring 214 illustrated in FIG. 3 has a different cross-section than the header ring 214 shown in FIG. 4, however, such a difference still illustrates problems associated with existing configurations. Additionally, the seal rings 216, 218 are shown as chevron v-rings. This configuration further illustrates the bead of the header ring 214 nestled within the groove of the v-ring.

Embodiments of the present disclosure overcome various drawbacks and problems with the illustrated prior art configurations. By way of example, embodiments may include a full radius at the entry feature to prevent a sharp edge where the seal could fatigue and initiate a tear. This gradual slopped radius also allows for easier installation of the plunger with a lower risk of causing damage to the header ring when installing the plunger, which is a common issue due to the nature of how the heavy and difficult to handle plungers are installed. Additionally, the outer diametrical surface has been tilted such that when the header ring is engaged around the plunger, the seal rocks slightly backwards until the outer diametrical surface is flush with the seal gland allowing for a tighter inner diameter fit with the same volume fill properties during seal energization.

Furthermore, the materials used to create the header rings and the pressure (V-rings) also offer improvements over current systems. The material used may be a base material of TPU with a 90 Durometer Shore A on the header ring and 60 Durometer Shore D on the chevron V rings. Additionally, in various embodiments, these may include reinforcing elements in the molding process such as carbon fiber, glass fiber, and/or aramid (Kevlar fibers). Embodiments may also incorporate boron fibers or ceramic fibers such as silicon carbide (SiC) or aluminum oxide (Al₂O₃). Additionally, embodiments may use nano-technology as stiffening elements such as the inclusion of graphene, white graphene (Boron Nitride), and carbon nanotubes, core-shell rubber (CSR) nano-particles, and nano-ceramic particles. Embodiments also provide improved manufacturing processes. For example, the sealing elements may be injection molded, which offers improvements over traditional compression molding or laminating processes.

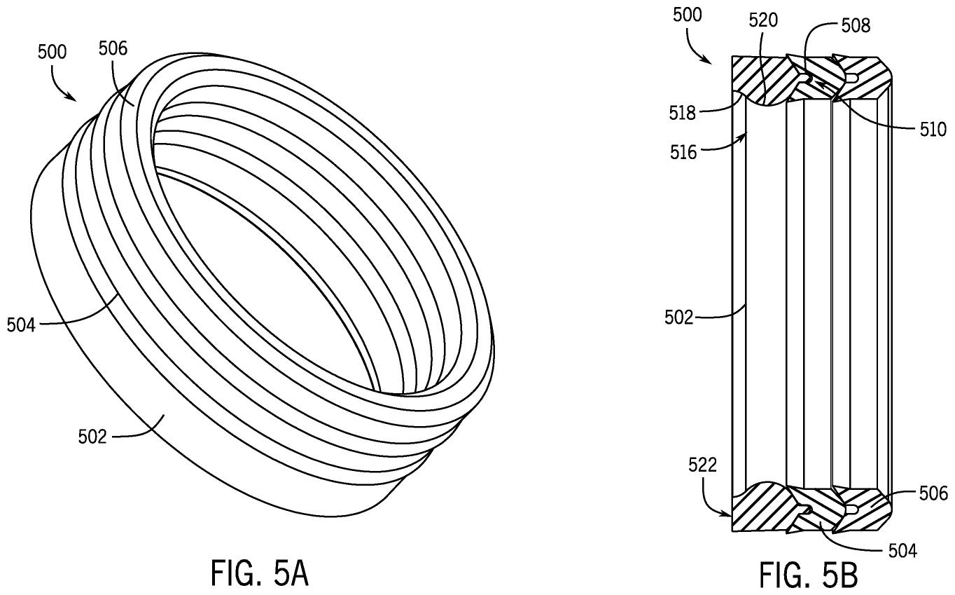

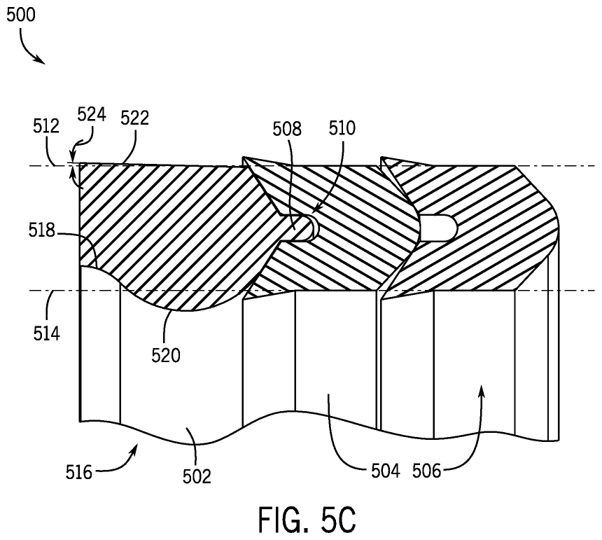

FIGS. 5A-5C illustrate a packing stack 500 wherein FIG. 5A provides a perspective view, FIG. 5B provides a cross-sectional view, and FIG. 5C provides a partial sectional view. The illustrated packing stack 500 includes a header ring 502 and seals 504, 506, which in this embodiment may be chevron v-rings. In various embodiments, the seals 504, 506 utilized may include commercially available components having standard dimensions. Various embodiments of the packing stack 500 shown in FIGS. 5A-5C include an improved header ring 502 that may be utilized with existing seals 504, 506.

FIGS. 5B and 5C illustrate the header ring 502 coupled to the seal 504 via a bead 508 that extends into a groove 510 formed in the seal 504. In operation, the stack 500 will be arranged between a packing bore wall (superimposed as line 512) and a reciprocating plunger surface (superimposed as line 514). It should be appreciated that the overlapping portions of the header ring 502 and the seals 504, 506 may be compressed against the wall 512 and the surface 514 and that the overlapping regions are shown illustrative of potential locations for these features. The illustrated front 516 (e.g., radially inward portion) of the header ring 502 includes a sloped entry radius 518. In this configuration, the sloped entry radius is in the form of a concave curve (relative to a protruding radius 520). In other words, the combination of the sloped entry radius 518 and the protruding radius 520 may form an “S” shaped curve along the front 516. It should be appreciated that the shape may be particularly selected for various embodiments and may include a combination of curves and flats and the “S” shaped curve is for illustrated purposes only.

Further illustrated in FIG. 5C is a tapered entry surface 522 opposite the front 516 (e.g., at a radially outward portion of the header ring 502). In contrast with the flat surface shown in FIG. 3, the illustrated embodiment includes the tapered entry surface 522 positioned at an angle 524 (with respect to an axis of the bore, which is substantially perpendicular to the bore wall 514), where the angle may be between approximately 0.25 and 8 degrees. This angle 524 may facilitate improved installation of the header ring 502, as well as provide an improved seal between the illustrated surfaces. As noted above, the header ring 502 includes the bead 508 that extends into the groove 510 to secure the header ring 502 to the seal 504. In various embodiments, as noted above, the seals 504, 506 may be of prior art design such that the header ring 502 may be utilized with traditional fittings to enable a retrofit to replace existing seal assemblies.

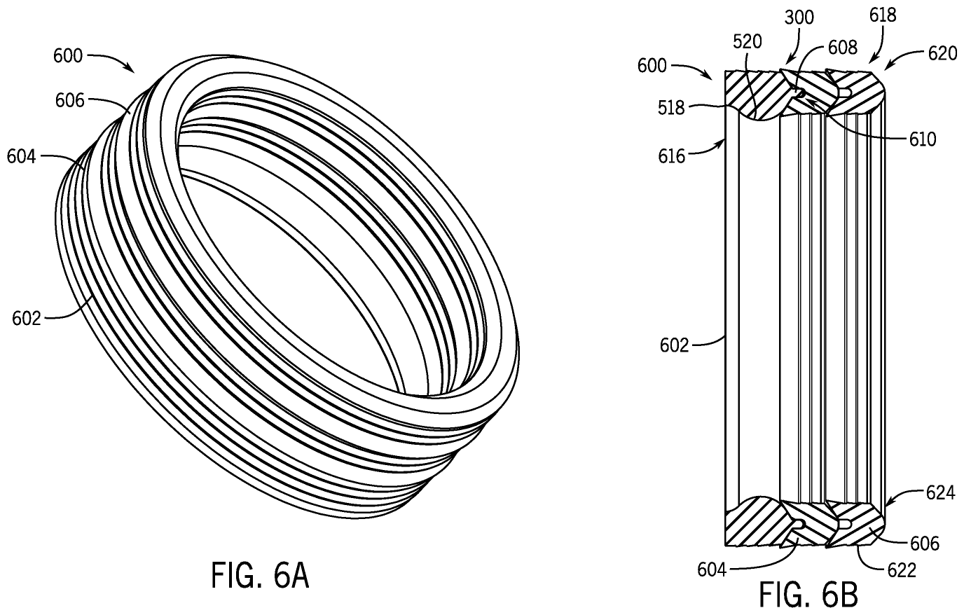

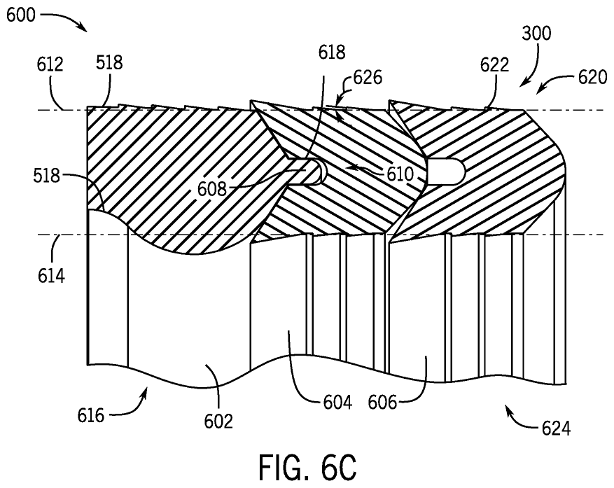

FIGS. 6A-6C illustrate a packing stack 600 wherein FIG. 6A provides a perspective view, FIG. 6B provides a cross-sectional view, and FIG. 6C provides a sectional view. The illustrated packing stack 600 includes a header ring 602 and seals 604, 606, which in this embodiment may be chevron v-rings, which include a revised geometry when compared to FIGS. 5A-5C. Accordingly, the packing stack 600 shown in FIGS. 6A-6C may include an improved header ring 602 that may be utilized with improved seals 604, 606.

FIGS. 6B and 6C illustrate the header ring 602 coupled to the seal 604 via a bead 608 that extends into a groove 610 formed in the seal 604. In operation, the stack 600 will be arranged between a packing bore wall (superimposed as line 612) and a reciprocating plunger surface (superimposed as line 614). As noted above, the locations of the lines 612, 614 may cause an overlap, which is for illustrative purposes only and would be representative of an area where the additional material is compressed or otherwise driven into the surfaces at those locations. The illustrated front 616 of the header ring 602 includes the sloped entry radius 518, described above with respect to FIGS. 5A-5C. The sloped entry radius 518 in this example is arcuate and forms an S-shaped configuration with the front 616, but it should be appreciated that other configurations may be utilized within the scope of the present disclosure. As shown in FIG. 6C, each of the header ring 602 and the seals 604, 606 include winglets 618 arranged on respective entry surfaces 300. The illustrated winglets 618 are shown on the outer diameters 620 (e.g., radially outward portions, out surfaces) and include a tapered body 622 arranged at an angle 626, which may be between 10 and 30 degrees in various embodiments. The winglets 618 provide additional sealing surface area to improve the sealing performance of the stack 600. It should be appreciated that the winglets 618 may also be incorporated with the tapered entry surface 520 described above.

The illustrated embodiment further includes the winglets 618 on an inner surface 624 (e.g., radially inward portion) of the seals 604, 606. In this configuration, the inner surface 624 is proximate the reciprocating plunger 106 (e.g., the surface 614). Moreover, it should be appreciated that there may be any reasonable number of winglets 618, and the illustrated two on each seal 604, 606 is for illustrative purposes only. In operation, pressure may apply a force in an upward direction (e.g., to the right relative to the plane of the page) and encounter the winglets 618. The pressure may cause the winglets 618 to pivot radially outwardly (e.g., rotate in a counter clockwise direction for the winglets 618 on the inner surface 624 and a clockwise direction for the winglets 618 on the outer surface 622) and increase the sealing pressure against the respective surfaces 612, 614. Accordingly, the sealing performance of the stack 600 may be improved.

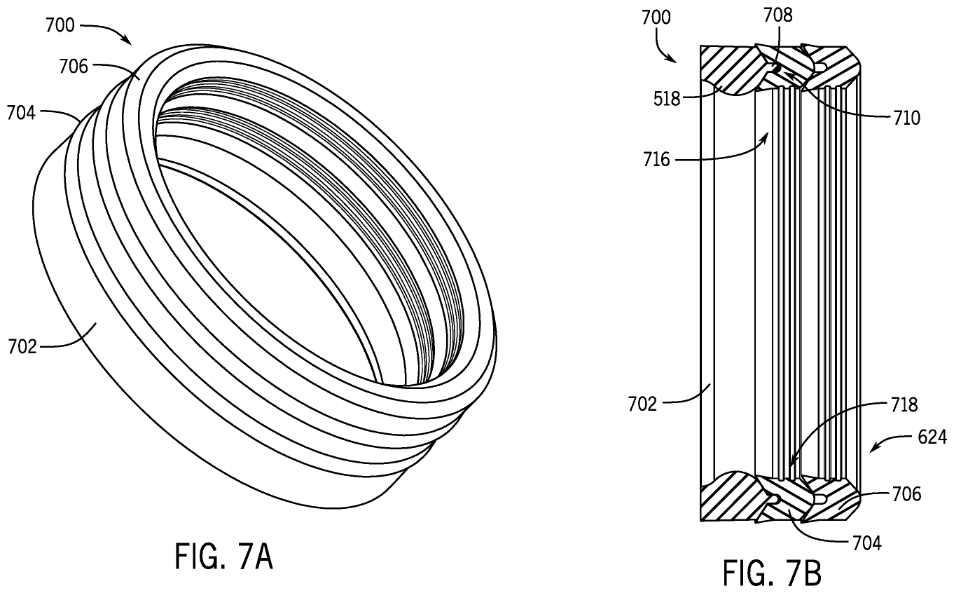

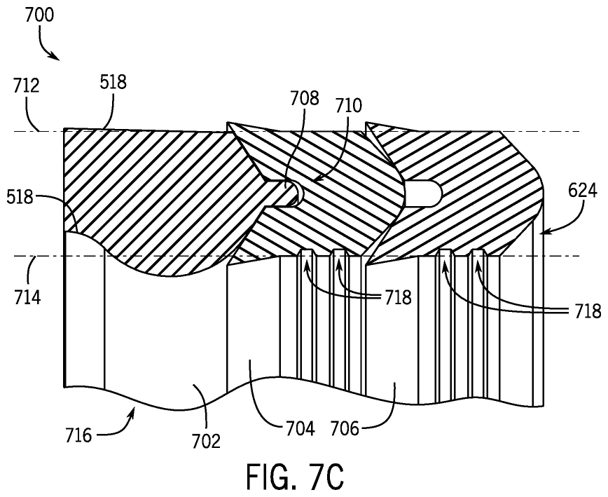

FIGS. 7A-7C illustrate a packing stack 700 wherein FIG. 7A provides a perspective view, FIG. 7B is a cross-sectional view, and FIG. 7C is a sectional view. The illustrated packing stack 700 includes a header ring 702 and seals 704, 706, which in this embodiment may be chevron v-rings, which include a revised geometry when compared to FIGS. 5A-6C. Accordingly, the packing stack 700 shown in FIGS. 7A-7C may include an improved header ring 702 that may be utilized with improved seals 704, 706.

FIGS. 7B and 7C illustrate the header ring 702 coupled to the seal 704 via a bead 708 that extends into a groove 710 formed in the seal 704. In operation, the stack 700 will be arranged between a packing bore wall (superimposed as line 712) and a reciprocating plunger surface (superimposed as line 714). As indicated above, the lines 712, 714 are for illustrative purposes to show where portions of the header ring 702 and seals 704, 706 would be compressed against the components. The illustrated front 716 of the header ring 702 includes the sloped entry radius 518, described about with respect to FIGS. 5A-5C. As shown in FIG. 7C, the inner surface 624 includes recesses 718, which in this configuration are annular half-moon channel recesses. However, it should be appreciated that the recesses 718 may be different shapes. Moreover, the recesses 718 may include any number of recesses, not just the illustrated two, and each recess may be a different shape. It should be appreciated that the shape of the recesses 718 may be particularly selected. As noted above, the recesses 718 may act as reservoirs for collecting lubricating grease or oil. Accordingly, as the plunger 106 (e.g., the surface 714) reciprocates, the lubrication may be distributed along a length of the plunger 106.

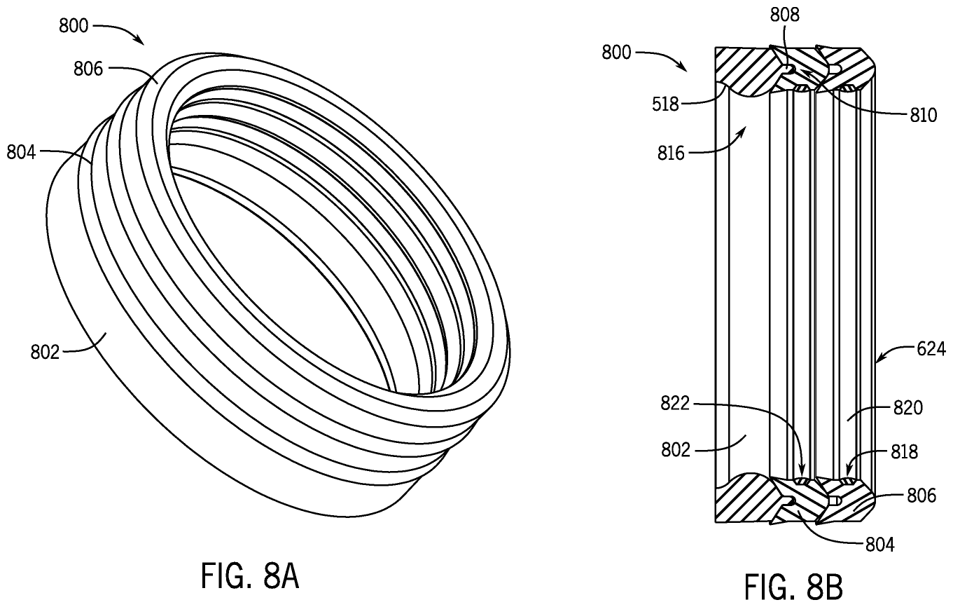

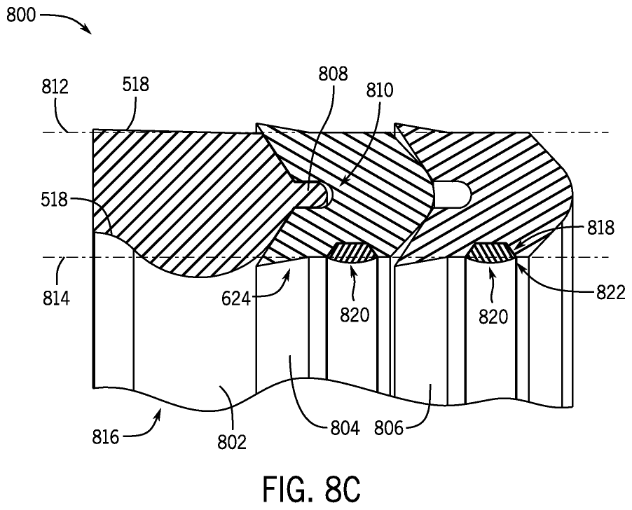

FIGS. 8A-8C illustrate a packing stack 800 wherein FIG. 8A provides a perspective view, FIG. 8B is a cross-sectional view, and FIG. 8C is a sectional view. The illustrated packing stack 800 includes a header ring 802 and seals 804, 806, which in this embodiment may be chevron v-rings, which include a revised geometry when compared to FIGS. 5A-7C. Accordingly, the packing stack 800 shown in FIGS. 8A-8C may include an improved header ring 802 that may be utilized with improved seals 804, 806.

FIGS. 8B and 8C illustrate the header ring 802 coupled to the seal 804 via a bead 808 that extends into a groove 810 formed in the seal 804. In operation, the stack 800 will be arranged between a packing bore wall (superimposed as line 812) and a reciprocating plunger surface (superimposed as line 814). The illustrated front 816 of the header ring 802 includes the sloped entry radius 518, described about with respect to FIGS. 5A-5C. As shown in FIG. 8C, the inner surface 624 includes a groove 818, that receives an insert 820. The illustrated groove 818 is a polygon that includes sloped sides and a base, however, it should be appreciated that a shape of the groove 818 may be particularly selected based on a variety of conditions and that the configuration shown in FIGS. 8A-8C are for illustrative purposes only. The insert 820 extends outwardly from the inner surface 624 of the seals 804, 806 to bear against the surface 814. That is, an insert contact surface 822 may extend radially inward more than the inner surface 624. In various embodiments, the insert is a PTFE/Teflon insert. The insert 820 may be bonded to the seals 804, 806 or snapped in place and may function as a low friction wiper seal to retain grease or lubrication close to the sealing areas of the seals 804, 806.

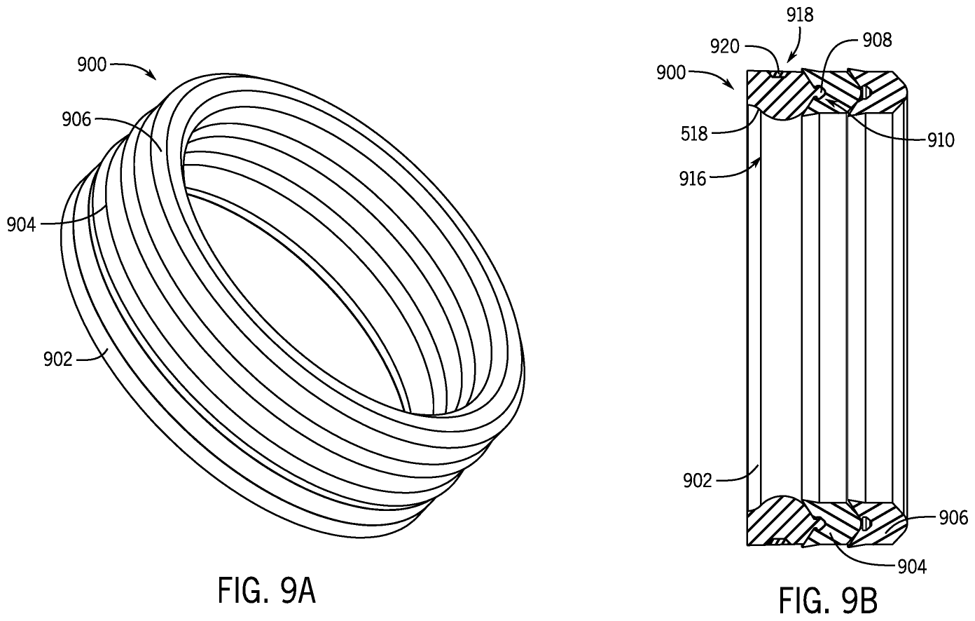

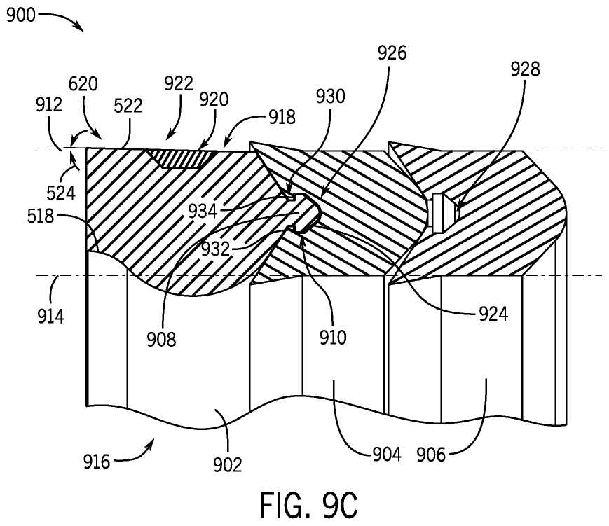

FIGS. 9A-9C illustrate a packing stack 900 wherein FIG. 9A provides a perspective view, FIG. 9B is a cross-sectional view, and FIG. 9C is a sectional view. The illustrated packing stack 900 includes a header ring 902 and seals 904, 906, which in this embodiment may be chevron w-rings, which include the prior art geometry shown in FIGS. 5A-5C and/or the revised geometries shown in FIGS. 6A-8C. Accordingly, the packing stack 900 shown in FIGS. 9A-9C may include an improved header ring 902 that may be utilized with improved seals 904, 906 and/or prior art seals.

FIGS. 9B and 9C illustrate the header ring 902 coupled to the seal 904 via a bead 908 that extends into a groove 910 formed in the seal 904. In operation, the stack 900 will be arranged between a packing bore wall (superimposed as line 912) and a reciprocating plunger surface (superimposed as line 914). The illustrated front 916 of the header ring 902 includes the sloped entry radius 518, described above with respect to FIGS. 5A-5C. As shown in FIG. 9C, the outer diameter 620 of the header ring includes a groove 918, that receives an insert 920, which may be a stiffener that acts as a reinforcement. In various embodiments, the stiffener or insert 920 may be formed from a PTFE/Teflon material or any other material that is stiffer than the material utilized to form the header ring 902. As will be appreciated, the insert 920 may be formed from a different material from the header ring 902 to provide additional support to the header ring 902. Furthermore, an insert outer diameter 922 may be larger than the outer diameter 620, substantially equal to the outer diameter 620, and/or smaller than the outer diameter 620. For example, a larger outer diameter 922 may provide an additional sealing interface and may drive the front 916 toward the plunger surface 914. Furthermore, a smaller outer diameter 922 may enable greater expansion and/or compression of the header ring 902. In certain embodiments, the outer diameter 922 may substantially conform to the outer diameter 620. That is, the outer diameter 922 may also include the tapered entry surface 522 to facilitate improved installation of the header ring 902. Accordingly, the outer diameter 922 of the insert 920 may be tapered or otherwise include a taper at the angle 524

Further illustrated is a barb 924 positioned on the bead 908. The barb 924 in the illustrated embodiment extends outwardly from the bead 908, and may be an integral part of the bead 908, thereby forming a mushroom shaped bead 908 that may provide improved connection to the groove 910. In various embodiments, a bead profile 926 may be substantially matched by a groove profile 928, which may include a reduced diameter portion 930 to reduce the likelihood that the bead 908 is inadvertently removed from the groove 910. For example, a shoulder 932 of the barb 924 may engage a stop 934 formed at the reduced diameter portion 920. It should be appreciated that the mushroom shaped profile 928 is for illustrated purposes only, and in various embodiments, may have a variety of different shapes. For example, the profile 928 may be T-shaped, include an arm on one end (e.g., shaped like a lower case “r”), or the like.

It should be appreciated that while various embodiments described herein are illustrated as separate configurations, that various embodiments may join or otherwise incorporate features into a single arrangement. By way of example, the winglets 618 may be utilized with the recesses 718 and/or the insert 820. Furthermore, the insert 920 in the header ring may be incorporated in embodiments of FIGS. 5A-8C. Accordingly, various embodiments may particularly select components to merge or otherwise incorporate into a packing stack.

The foregoing disclosure and description of the disclosed embodiments is illustrative and explanatory of the embodiments of the disclosure. Various changes in the details of the illustrated embodiments can be made within the scope of the appended claims without departing from the true spirit of the disclosure. The embodiments of the present disclosure should only be limited by the following claims and their legal equivalents.

1. A sealing assembly for a pump, comprising:
a header ring having a tapered radially outer surface and a sloped radially inner surface, the sloped radially inner surface extending from a planar bottom surface to a second sloped surface, the second sloped surface extending toward the tapered radially outer surface to a bead;
a first seal configured to couple to the header ring, the first seal having a groove that receives the bead extending from the header ring; and
a second seal axially aligned with the first seal.

2. The sealing assembly of claim 1, wherein the sloped radially inner surface has an arcuate shape.

3. The sealing assembly of claim 1, further comprising:
a plurality of winglets arranged on at least one of the header ring, the first seal, or the second seal, each winglet of the plurality of inlets including an arm, extending radially outward from a respective body, the arm positioned at an angle with respect to an axis of a pump bore.

4. The sealing assembly of claim 3, wherein the plurality of winglets are arranged on the tapered radially outer surface.

5. The sealing assembly of claim 3, wherein the plurality of winglets are arranged on at least one of a first seal outer surface, a first seal inner surface, a second seal outer surface, a third seal outer surface.

6. The sealing assembly of claim 1, further comprising:
a recess formed along at least one of a first seal inner surface or a second seal inner surface, the recess extending radially inward with respect to the at least one first seal inner surface or the second seal inner surface, the recess configured to collect and distribute lubricating fluid along a reciprocating plunger.

7. The sealing assembly of claim 1, further comprising:
a recess formed along at least one of a first seal inner surface or a second seal inner surface, the recess extending radially inward with respect to the at least one first seal inner surface or the second seal inner surface; and
an insert configured for insertion into the recess, an inner contact surface of the insert extending farther radially inward than at least one of the first seal inner surface or the second seal inner surface.

8. The sealing assembly of claim 7, wherein the insert is formed from a low friction material.

9. The sealing assembly of claim 1, further comprising:
a recess formed in the tapered radially outer surface; and
an insert configured for insertion into the recess, the insert being formed from a different material from the header ring.

10. The sealing assembly of claim 1, wherein at least one of the header ring, the first seal, or the second seal is formed, at least in part, from a thermoplastic polyurethane (TPU).

11. The sealing assembly of claim 1, wherein at least one of the header ring, the first seal, or the second seal is formed, at least in part, from a polyurethane composite including at least one of glass fibers, carbon fibers, carbon nanotubes, graphene, polytetrafluoroethylene (PTFE), aramid-fabrics, Kevlar fabrics, alumina powder, ceramic fiber, white graphene, or nano-ceramics.

12. A pumping system, comprising:
a housing;
a plunger configured to reciprocate along an axis of the housing; and
a packing assembly positioned between at least a portion of the housing and the plunger, the packing assembly comprising:
a header ring having an outer surface bearing against the housing and an inner surface bearing against the plunger, the header ring having a thickness such that the plunger compresses the header ring against the housing, wherein the outer surface includes tapered portion and the inner surface includes sloped entry radius at an axially bottom portion, the sloped entry radius having a curvature that begins at the bottom portion; and
a seal positioned axially higher than and coupled to the header ring, the seal having a groove configured to receive a bead of the header ring, the bead extending axially away from the bottom portion, wherein the seal includes a radially extending sealing feature along a length of the seal.

13. The system of claim 12, wherein the radially extending sealing feature further comprises:
a winglet extending from at least one of an inner seal surface or an outer seal surface, the winglet arranged at an angle with respect to the axis and configured to rotate about an attachment point responsive to an external force.

14. The system of claim 12, wherein the radially extending sealing feature further comprises:
an insert configured for insertion into a recess formed in the seal, an inner contact surface of the insert extending farther radially inward toward the plunger than at least a portion of an inner seal surface.

15. The system of claim 12, wherein the groove includes a groove profile that substantially conforms to a bead profile.

16. The system of claim 12, wherein the bead further comprises:
a shoulder extending radially away from a bead body, the shoulder extending a stop formed within the groove to block removal of the bead from the groove.

17. The system of claim 12, wherein the header ring further comprises:
a recess formed in the outer surface; and
an insert configured for insertion into the recess, the insert being formed from a different material than the header ring, the insert having a taper that substantially conforms to the tapered portion.

18. The system of claim 12, wherein the seal is formed from a composite material including at least two of polyurethane, glass fibers, carbon fibers, carbon nanotubes, graphene, polytetrafluoroethylene, aramid-fabrics, Kevlar fabrics, alumina powder, ceramic fiber, white graphene, or nano-ceramics.

19. A packing stack, comprising:
a header ring extending axially from a bottom to a top, the top having a bead, the header ring having an inner surface with a curved profile extending from a first sloped top entry to the bottom, a bottom thickness being less than a midpoint thickness, and an outer surface with a tapered profile extending from a second sloped top entry to the bottom, the tapered profile arranged at an angle such that a top thickness is less than the bottom thickness; and
a seal extending axially from a bottom end to a top end, at least a portion of the bottom end overlapping the top of the header ring, the seal having a groove that receives the bead, an inner seal surface, and an outer seal surface, the seal being positioned axially aligned with the header ring.

20. The packing stack of claim 19, further comprising:
a plurality of winglets arranged on at least one of the header ring or seal, each winglet of the plurality of inlets including an arm, extending radially outward from a respective body, the arm positioned at an angle with respect to an axis of the respective body.

21. The packing stack of claim 19, further comprising:
a recess formed along the seal, the recess extending radially inward with respect to the inner seal surface, the recess configured to collect and distribute lubricating fluid along a reciprocating plunger.

22. The packing stack of claim 19, further comprising:
an insert positioned within at least one of the header ring or the seal.

23. The packing stack of claim 19, wherein at least one of the header ring, or the seal is formed, at least in part, from a thermoplastic polyurethane (TPU).

24. The packing stack of claim 19, wherein at least one of the header ring or the second seal is formed, at least in part, from a polyurethane composite including at least one of glass fibers, carbon fibers, carbon nanotubes, graphene, polytetrafluoroethylene (PTFE), aramid-fabrics, Kevlar fabrics, alumina powder, ceramic fiber, white graphene, or nano-ceramics.
